(19) United States
(12) Patent Application Publication
(10) Pub. No.: US 2013/0091018 A1
(43) Pub. Date: Apr. 11, 2013

(54) METHOD, SERVER AND COMPUTER READABLE RECORDING MEDIUM FOR PROVIDING SOCIAL-COMMERCE DEAL WITH ROUTE INFORMATION

(71) Applicant: NHN CORPORATION, Seongnam-si (KR)

(72) Inventors: Byoung Seok YANG, Seongnam-si (KR); Seung Phill LIM, Seongnam-si (KR); Hyung Seok KO, Seongnam-si (KR)

(73) Assignee: NHN CORPORATION, Seongnam-si (KR)

(21) Appl. No.: 13/645,004

(22) Filed: Oct. 4, 2012

(30) Foreign Application Priority Data
Oct. 11, 2011 (KR) 10-2011-0103633

(51) Int. Cl. G06Q 30/02

(52) U.S. Cl. 705/14.58

(57) ABSTRACT

Disclosed herein are a method, a server, and a computer readable recording medium for providing social-commerce deals with route information. According to an exemplary embodiment of the present invention, there is provided a method for providing social-commerce deals with route information executed by a social-commerce server, method including receiving route request information from a user terminal and calculating route information based on the received route request information, extracting recommendation social-commerce deal information based on the calculated route information, and providing the calculated route information and the extracted recommendation social-commerce deal information to the user terminal.

### CROSS-REFERENCE TO RELATED APPLICATIONS

This application claims priority from and the benefit of Korean Patent Application No. 10-2011-0103633, filed on Oct. 11, 2011, which is hereby incorporated by reference for all purposes as if fully set forth herein.

### BACKGROUND OF THE INVENTION

1. Field of the Invention

The present invention relates to a method, a server, and a computer readable recording medium for providing social-commerce deals with route information, and more particularly, to a method, a server, and a computer readable recording medium for providing social-commerce deals with route information, in which optimal routes requested by users are calculated and social-commerce deal information of businesses located around the calculated optimal routes is extracted as recommended social-commerce deal information so as to be provided to users.

2. Discussion of the Background

With the development of information communication technologies, purchase patterns of articles or services have shifted from off line commerce to electronic commerce (e-commerce). In early stage of e-commerce, users access Internet sites that merely sell articles/services to purchase their desired articles/services. However, with the development of mobile devices, e-commerce techniques using activated social network services (SNS) have been developed. The e-commerce technique using the SNS is referred to as social-commerce or social shopping and is a sale method that provides goods to purchasers at a substantial discount when a predetermined number of purchasers are gathered. In particular, the social-commerce has been interested as a new consuming market with the popularization of a smart phone and a use of a social network service. Goods (social-commerce deals) registered by the social-commerce businesses are generally sold 24 hours at a high discount rate from about 50% to 90%. However, the e-commerce technique is limited by the number of purchasers that purchase goods. For example, when more than 100 purchasers purchase goods, a fixed price of the goods are discounted by 50%.

In the early stage, the social-commerce services are served by a method of exposing all the registered social-commerce deals to customers (users). However, with the development of mobile communication devices, and the like, a method of determining areas currently accessed by users by interworking with a user location based service (LBS) and primarily exposing social-commerce deals registered by corresponding local businesses to users has been developed to provide services. A method for displaying advertisement interworking with the user location based service is disclosed in Korean Patent Laid-Open Publication No. 10-2011-0043143 (System And Method For Mobile Advertisement Based On User Information, laid-open published on Apr. 27, 2011). The foregoing related art provides mobile advertisement based on current location and time and user's taste, in particular, provides advertisement when users are located in one area for predetermined time and manages the provided advertising history to prevent the same advertisements from being repeatedly provided or advertisement from being provided too frequently, thereby achieving a high advertising effect. In particular, the related art discloses contents of providing targeted advertisement to users at appropriate time to prevent the corresponding advertisement from being recognized as spam advertisement.

However, the advertising service and/or the social-commerce deal exposure service interworking with the user location based service do not reflect the location change of users when users are on the journey or on the move.

### SUMMARY OF THE INVENTION

Exemplary embodiments of the present invention have proposed to solve the problems of the related art as described above.

An exemplary embodiment of the present invention provides a method, a server, and a computer readable recording medium for providing social-commerce deals with route information, in which optimal moving routes requested by users are calculated and social-commerce deals within a predetermined range are extracted from a moving route based on the calculated moving routes so as to be provided to the users.

An exemplary embodiment of the present invention provides a method, a server, and a computer readable recording medium for providing social-commerce deals with route information, in which optimal moving routes requested by users are calculated and social-commerce deals appropriately used by the users are extracted based on the calculated moving route and information on estimated time when the users arrive at deal target businesses so as to be provided to the users.

An exemplary embodiment of the present invention provides a method, a server, and a computer readable recording medium for providing social-commerce deals with route information, in which optimal moving routes requested by users are calculated and it is determined whether the users own social-commerce coupons used on a currently moving route based on the calculated moving routes, and if is determined that the users own the usable coupons, coupon use recommendation is provided to the users.

An exemplary embodiment of the present invention provides a method, a server, and a computer readable recording medium for providing social-commerce deals with route information, in which estimated time when users arrive at specific businesses is calculated using their own route information and information on the calculated estimated time of arrival of users is provided to advertisers operating the corresponding businesses, such that the advertisers can estimate and control the visiting time of the users.

According to an exemplary embodiment of the present invention, there is provided a method for providing social-commerce deals with route information executed by a social-commerce server, including: receiving route request information from a user terminal and calculating route information based on the received route request information; extracting recommendation social-commerce deal information based on the calculated route information; and providing the calculated route information and the extracted recommendation social-commerce deal information to the user terminal.

According to an exemplary embodiment of the present invention, there is provided a server providing social-commerce deals with route information, including a route calculator configured to receive route request information from a user terminal and calculate route information based on the received route request information; and a social-commerce deal extractor configured to extract recommendation social-commerce deal information based on the calculated route information and provide the calculated route information and the extracted recommendation social-commerce deal information to the user terminal.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a configuration block diagram of an overall system according to an exemplary embodiment of the present invention;

FIG. 2 is a configuration block diagram of a social-commerce server according to an exemplary embodiment of the present invention; and

FIG. 3 is a flow chart showing a process of providing social-commerce deals with route information according to an exemplary embodiment of the present invention.

### DETAILED DESCRIPTION OF THE ILLUSTRATED EMBODIMENTS

Hereinafter, exemplary embodiments of the present invention will be described in detail with reference to the accompanying drawings. These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying s claims and their equivalents if appropriate. Similar reference numerals will be used to describe the same or similar functions throughout the accompanying drawing.

In exemplary embodiments of the present invention, the term “social-commerce deal” means goods registered in a social-commerce server so as for social-commerce businesses to sell the goods through e-commerce in a social-commerce type, but is not necessarily limited thereto and therefore, is not to be restrictively construed according to types of specific e-commerce as far as it includes the gist of the present invention.

In addition, the term “social-commerce coupon”, which is material and/or immaterial information provided to a user as the result that the user purchases specific social-commerce deals, may be a serial number type, a graphic image type, or other information types. The social-commerce coupons may be stored in a user terminal or other types of information storage media.

Further, the term “preset distance”, which is information used to extract the social-commerce deals, means a preset radius distance so as to extract social-commerce businesses adjacent to a calculated route.

In addition, the term “WAP” means Wireless Application Protocol (WAP) which is a technical standard for accessing information over a mobile wireless network. A WAP page is a web page for mobile devices such as mobile phones (called “cellular phones” or “mobile phones”) or any mobile computing device that use the protocol.

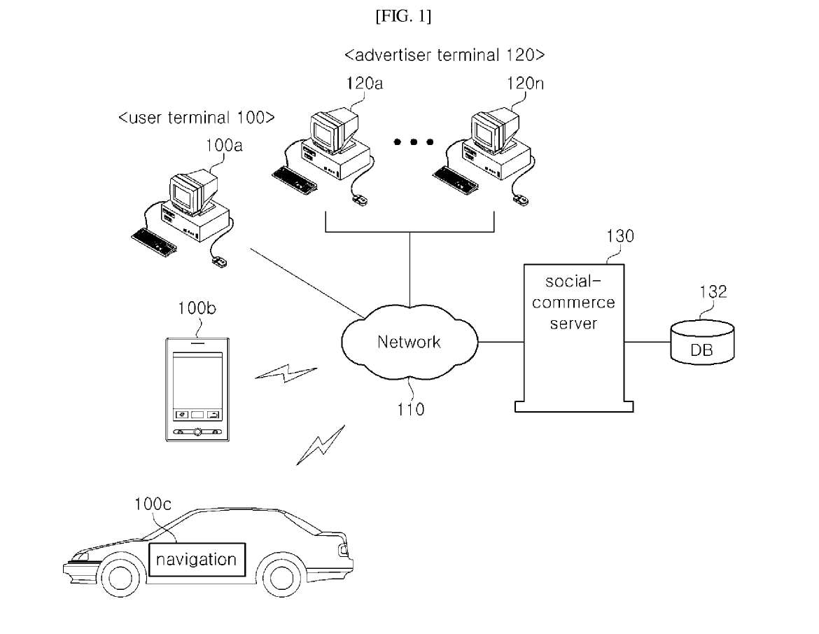

FIG. 1 is a configuration block diagram of an overall system according to an exemplary embodiment of the present invention. Hereinafter, a configuration and a function of an overall system according to exemplary embodiments of the present invention will be described with reference to FIG. 1.

As shown in FIG. 1, an overall system according to an exemplary embodiment of the present invention may include a user terminal 100, an advertiser terminal 120, and a social-commerce server 130. The user terminal 100, the advertiser terminal 120, and the social-commerce server 130 may be connected to one another via network 110.

The user terminal 100 accesses the social-commerce server 130 through the network 110 according to an operation of a user and then, transmits route request information including an origination and a destination to the social-commerce server 130 and performs a function of receiving and outputting route information, recommendation social-commerce deal information, and coupon use recommendation information transmitted from the social-commerce server 130. In this case, the route request information transmitted from the user terminal 100 to the social-commerce server 130 may further include passage information and mobile device information, in addition to origination information and destination information as described above.

The user terminal 100 may be any suitable communication device. Herein, any digital device having operation capability by including a memory and a microprocessor and data communication capability through a network, a desk top computer, a notebook computer, a workstation, a palmtop computer, a personal digital assistant (PDA), a web pad, and a smart phone, navigation terminals installed in a vehicle, and the like, may be adopted as the user terminal 100 according to the exemplary embodiments of the present invention. When the user terminal 100 is implemented using mobile communication terminals, navigation terminals, any device configured to run applications, the user terminal 100 may be configured to include dedicated applications that can access the social-commerce server 130 according to the exemplary embodiment of the present invention to search moving routes and receive social-commerce services.

The route information, the recommended social-commerce deal information, the coupon use recommendation information, and the like, transmitted from the social-commerce server 130 may be configured to be displayed on a single screen on the user terminal 100, that is, an electronic map on which the calculated optimal routes are displayed, together with brief information (company name, telephone number, and the like) of recommended social-commerce deal target businesses and/or brief information (company name, telephone number, and the like) of coupon use recommendation businesses. In this case, when the user selects the specific brief information (deal information or coupon information) displayed on the electronic map (by mouse operation, touch, and the like), the user terminal may be configured to output detailed information regarding brief information selected by a user on a screen.

On the other hand, the social-commerce server 130 is configured to provide the calculated optimal routes and the recommendation social-commerce deal information and/or the coupon use recommendation information, together with the electronic map on pages provided as a web page, a wap page, or a web page for a smart phone, and the like, that are provided to the user terminal 100 so as to be provided to the user terminal 100. Alternatively, according to an exemplary embodiment of the present invention, when the user terminal 100 is configured as a terminal including a function of creating/outputting the electronic map like navigation terminals and information communication devices in which navigation applications are mounted, the social-commerce server 130 may also be configured to transmit the calculated optimal route information, the recommendation social-commerce deal information, and/or the coupon use recommendation information to the user terminal 100 and display information transmitted through the applications that are installed in the user terminal 100.

In addition, the user terminal 100 according to an exemplary embodiment of the present invention performs a function of outputting the recommendation social-commerce deal information transmitted together with the route information, transmitting a purchase request for the specific social-commerce deals to the social-commerce server 130 when the user wants to purchase the specific social-commerce deals, interworking with the social-commerce server 130 to perform a series of e-commerce processes for purchasing the social-commerce deals, and when the purchase for the social-commerce deals is successfully completed, receiving and storing coupon information used in the corresponding social-commerce deal target businesses from the social-commerce server 130. The social-commerce deal purchase process between the social-commerce server 130 and the user terminal 100 may adopt any suitable technology, including known technologies and therefore, the detailed description thereof will be omitted herein.

Further, the user terminal 100 according to an exemplary embodiment of the present invention may be configured to further serve to transmit use confirmation information or reservation request for specific coupons to the social-commerce server 130. That is, the user that confirms the coupon use recommendation information displayed together with the route information selects the coupons of the specific social-commerce businesses, the user terminal 100 may be configured to transmit the use confirmation information or the reservation request information to the social-commerce server 130 according to the operation of the user and the social-commerce server 130 may be configured to receive the use confirmation information or the reservation request information and transmit the reservation information to the advertiser terminal 120 of the corresponding businesses.

According to an exemplary embodiment of the present invention, the network 110 may be configured independent of communication aspects such as a wired type, a wireless type, and the like, and may be configured of various communication networks, such as a personal area network (PAN), a local area network (LAN), a metropolitan area network (MAN), a wide area network (WAN), and the like.

The advertiser terminal 120 is first configured to serve to perform the registration and purchase processing of the general social-commerce deals. The terminal 120 may also be configured to receive and output the social-commerce deal purchase complete information of the specific user and the reservation information on the specific social-commerce coupons owned by the user that are transmitted from the social-commerce server 130. In this case, the social-commerce deal purchase complete information or the reservation information on the social-commerce coupons that are transmitted from the social-commerce server 130 may include the calculated moving route, current traffic situation, and the information on the estimated time when the user of the user terminal 100 arrives at the corresponding businesses, which is calculated in the social-commerce server 130 based on the mobile device information of the user, as described above. In this case, the advertiser may use the information on the estimated time when the user arrives at the businesses that are output through the advertiser terminal 120 to estimate the visiting time of the user and may control the situations of the businesses in consideration of the seat situations, and the like, within the businesses. Further, as described above, the estimated time when the user arrives at the businesses is automatically calculated in the social-commerce server 130 and is transmitted. When the user operates the user terminal 100 to set a separate reservation time, the reservation time information set by the user may also be transmitted and displayed to the advertiser terminal 120. The advertiser terminal 120 may be suitable communication devices. Herein, any digital device having operation capability by including a memory and a microprocessor and data communication capability through a network, such as a desk top computer, a notebook computer, a workstation, a palmtop computer, a personal digital assistant (PDA), a web pad, and a smart phone may be adopted as the advertiser terminal 120 according to the exemplary embodiments of the present invention. When the advertiser terminal 120 is implemented using the smart phone or any computing device configured to run application, the advertiser terminal 120 may be mounted with dedicated applications that access the social-commerce server 130 according to the exemplary embodiment of the present invention to perform the foregoing functions.

The social-commerce server 130 performs a function of performing the provision and purchase process of the social-commerce deals and in addition to the general social-commerce function, performs a function of calculating the route according to the exemplary embodiment of the present invention and determining the social-commerce deals adjacent to the calculated route as the recommendation social-commerce deals, thereby providing the determined social-commerce deals to the user terminal 100 together with the calculated route. The provision and purchase processing of the social-commerce deals of the social-commerce server 130 may use any known technology or any suitable technology and therefore, the detailed description thereof will be omitted herein. Hereinafter, the configuration and function of the social-commerce server 130 according to an exemplary embodiment of the present invention will be mainly described.

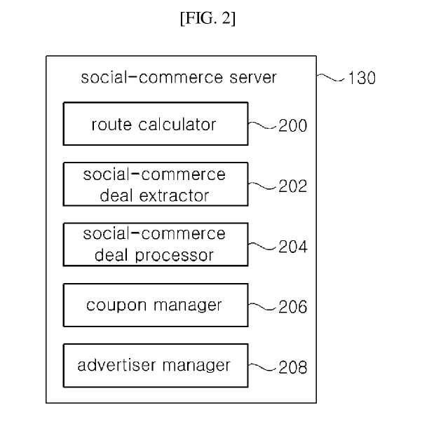

As described above, the social-commerce server 130 performs a function of calculating the optimal route information using the route request information transmitted from the user terminal 100, determining and extracting the social-commerce deal information around the calculated route among the social-commerce deal information registered in a database 132 as the recommendation social-commerce deal information, and providing the calculated route information and the extracted recommendation social-commerce deal information to the user terminal 100 requesting the route. The detailed configuration and function of the social-commerce server 130 will be described below with reference to FIG. 2.

FIG. 2 is a configuration block diagram of a social-commerce server according to an exemplary embodiment of the present invention. As shown in FIG. 2, the social-commerce server 130 according to the exemplary embodiment of the present invention may include a route calculator 200, a social-commerce deal extractor 202, a social-commerce deal processor 204, a coupon manager 206, and an advertiser manager 208. Herein, any server computer device having operation capability by including one or more storage devices, one or more microprocessors configured to communicate with the one or more storage devices, and data communication capability through a network may be used to implement the social-commerce server 130.

The route calculator 200 according to an exemplary embodiment of the present invention performs a function of receiving the route request information transmitted from the user terminal 100 and calculating the optimal routes requested by the user using information included in the route request, that is, the origination information, the destination information, the passage information, and the mobile device information, based on a preset optimal route calculation algorithm based on electronic map data stored in the database 132. The route calculator 200 performs a function of calculating the optimal routes according to conditions (for example, a shortest distance, shortest time, costs, and the like) set by the user that are supported in the generally used navigation terminal, electronic map server, and the like, and in some case, receiving the current traffic situation information provided from an external traffic information server (not shown) and calculating estimated time consumed to arrive at specific points around the calculated route using the mobile device selected by the user to calculate the information on the estimated time of arrival at the specific points (shops of the social-commerce deal businesses purchased by the user, shops of businesses providing coupons that the user decides to use, and the like). The information on the estimated time of arrival at the specific points around the route calculated by the route calculator 200 according to the foregoing method may be used to determine the recommendation social-commerce deals and provide the information on the estimated time when the user arrives at the social-commerce businesses selected by the user. In order to calculate the information on the estimated time of arrival, the route calculator 200 according to an exemplary embodiment of the present invention receives departure time (or, information that “the user is currently on the move”, and the like) as the route request information to calculate the information on the estimated time of arrival at the specific points from the user terminal 100.

The social-commerce deal extractor 202 according to an exemplary embodiment of the present invention performs a function of determining the appropriate social-commerce deals among the plurality of social-commerce deals registered in the social-commerce server 130 as the deals based on the optimal routes calculated in the route calculator 200 and providing the determined social-commerce deals to the user terminal 100. The social-commerce deal extractor 202 may be configured to determine the recommendation social-commerce deals based on two references at large (the exemplary embodiment of the present invention may also apply only one of two references according to the configuration and may apply both of the two references).

First, the social-commerce deal extractor 202 may determine the recommendation social-commerce deals based on the location of the social-commerce businesses and the distance between the calculated optimal routes. That is, the social-commerce deal extractor 202 performs a function of determining as the recommendation social-commerce deals the deals of the social-commerce businesses located within the preset distance from the optimal routes based on the optimal routes calculated in the route calculator 200 and providing the determined the recommended social-commerce deals to the user terminal 100. For example, when the distance is set to be 100 meters, the social-commerce deal extractor 202 determines as the recommendation social-commerce deals the social-commerce deals of the businesses if it is determined that the corresponding businesses are located within 100 meters from the calculated optimal route, based on the location information of the social-commerce target businesses among the registered social-commerce deals. The preset distance may be used at the time of the primary search/extraction in the state in which a basic value is set and when the recommendation social-commerce deal information is provided to the user terminal 100 and then, the presetdistance is reset according to the operation of the user, the recommendation social-commerce deal information may be again extracted based on the reset preset distance, which may be in turn provided to the user terminal 100. In addition, a manager of the social-commerce server 130 may also change an preset distance basic value set in the social-commerce server 130 using a manager terminal (not shown). According to the configuration of the exemplary embodiment of the present invention, the preset distance may be a radius distance (means a straight distance to a business location based on a central point of the route) or may also be the additional moving distance (means a distance that is to be moved to the corresponding business location getting out of the route, based on the route). For example, when the preset distance is a radius distance and is set to be 100 meters, the social-commerce deal extractor 202 determines and extracts the social-commerce deal of the businesses having shops within a radius distance 100 meters from the calculated route as the recommendation social-commerce deal. On the other hand, for example, when the preset distance is an additional moving distance and is set to be 1 km, the social-commerce deal extractor 202 determines and extracts the social-commerce deal of the businesses having shops within an additional moving distance 1 Kilometers from the calculated route as the recommendation social-commerce deal. The preset distance (the types and/or the distance setting of the preset distance used to determine the recommendation social-commerce deals) may be set by a manager of the social-commerce server 130. Alternatively, an interface that can set the preset distance is provided in the user terminal 100, wherein the preset distance may also be configured to be set or reset using the setting information input to the corresponding interface according to the operation of the user.

In addition, the social-commerce deal extractor 202 may be configured to determine/extract the recommendation social-commerce deals using the information on the estimated time of arrival at the social-commerce deal businesses around the route calculated by the route calculator 200. In this case, the social-commerce deal extractor 202 may serve to determine the recommendation social-commerce deals according to the preset recommendation reference based on the estimated time of arrival. This is provided to recommend the meaningful social-commerce deals to the user. For example, when the user requests the route information to the social-commerce server 130 in the state in which the user operates the user terminal 100 to set an origination as Seoul City and a destination as Busan City and sets the departure time as 10 AM, the route calculator 200 of the social-commerce server 130 uses the information included in the route request information of the user to calculate the optimal routes from Seoul to Busan City according to the setting of the user, and the social-commerce deal extractor 202 extracts the social-commerce deal information around the calculated route and then, determines the recommendation social-commerce deal information among the social-commerce deal information around the extracted route (in this case, the reference determining that the social-commerce deal information is around the route may be the foregoing preset distance and separate reference may be applied) based on the set recommendation information. In this case, the used recommendation information may be configured to store the business information that is a recommendation target for each time in a table form. For example, the recommendation information may be configured to set as a recommendation target business a restaurant business so that a user can have a meal, in the meal time (for example, 7 to 9 AM, 11:30 AM to 1:30 PM, 6:00 to 8:30 PM, and the like) and as a recommendation target business a tourist/leisure business that can be used by the user, in the tourist/leisure time (for example, 9 AM to 7 PM, and the like), and as the recommendation target business a hotel business that can be used by a user, in the lodging time (for example, 8 PM to 6 AM next day). In the foregoing example, when the social-commerce deals searched around the calculated route are two (A deal and B deal) in the restaurant business, the estimated time of arrival at shops of the business providing the A deal is 10:30, and the estimated time of arrival at shops of the business providing the B deal is twelve o'clock, based on the estimated time of arrival at the corresponding businesses, the social-commerce deal extractor 202 predicts that the user does not arrive at shops of the corresponding business in the recommendation time of the restaurant business in the case of the A deal and therefore, excludes the A deal from the recommendation target and predicts that the user arrives at shops of the corresponding business in the recommendation time of the restaurant business in the case of the B deal and determine the B deal as the recommendation target and provides the determined recommendation target to the user. The following Table 1 shows a configuration of exemplary recommendation information. The configuration of the recommendation information may be variously changed/modified as needed and is not necessarily limited to the following Table.

TABLE 1

| Estimated Time Of | Recommendation |
|---|---|
| Arrival At Shop | Target Business |
| 7 to 9 AM, 11:30 AM to 1:30 PM, | Restaurant Business |
| 6:00 to 8:30 PM | |
| 9:00 AM to 7:00 PM | Tourist/Leisure Business |
| 10:00 AM to 9:00 PM | Shopping Business |
| 8:00 PM to 6:00 AM Next Day | Lodging Business |

In some exemplary embodiments of the present invention, the social-commerce deal information on too many businesses may be extracted in the overlapping time and therefore, priority for each business may also be set according to each time. For example, when the restaurant business and the tourist/leisure business are contending, the exemplary embodiment of the present invention can be configured to set the restaurant business as a first priority and set the tourist/leisure business as a second priority to primarily provide more information of the restaurant business and provide the relatively less information of the tourist/leisure business. The setting of the priority and the amount of information to be provided according to the priority may be set/changed by the control/setting command transmitted from the manager terminal as needed. The setting of the priority and the amount of information to be provided according to the priority may also be set at the user terminal.

In addition, the social-commerce deal extractor 202 may also be configured to determine and extract as the recommendation social-commerce deal information the social-commerce deal information that can be used at the estimated time when the user arrives at the social-commerce deal target businesses among the plurality of social-commerce deals around the calculated route as the registered social-commerce deals. Considering the characteristics of the social-commerce, in the case of the social-commerce deal, the purchase possible time and the usable time of the deals are mostly set in advance. Therefore, the social-commerce deal extractor 202 may be configured to purchase the deals at the requested time and determine as the recommendation social-commerce deals the social-commerce deals of the businesses in which the coupons of the user can be used according to the deal purchase while the user moves along the calculated route and provide the determined recommendation social-commerce deals to the user. For example, when the user transmits the route request information (origination: Seoul city, destination: Busan city, departure time: 10 AM next day) using the user terminal 100, the route calculator 200 calculates the optimal routes (including the information on the estimated time of arrival for each specific point, and the like) from Seoul city to Busan city according to the conditions set by the user and the social-commerce deal extractor 202 once extracts all the social-commerce deals around the calculated route. The social-commerce deal extractor 202 may be configured to use the information on the estimated time of arrival at the corresponding businesses, which is calculated for the extracted social-commerce deal target businesses to purchase the route information within the estimated time of arrival at the corresponding businesses calculated from the requested time and to determine as the recommendation social-commerce deals the social-commerce deals of the businesses in which the coupons of the user can be used according to the purchase of the deals of the corresponding businesses at the calculated estimated time of arrival at the corresponding businesses. In the foregoing example, when three social-commerce deals [(A deal-purchase possible period: October 1 to October 2, usable period: 10 AM to 2 PM October 2, estimated time of arrival at target business: 11:30 AM October 2), (B deal-purchase possible period: October 1, usable period: 6 PM to 10 PM October 2, estimated time of arrival at target business: 1:30 PM October 2), (C deal-purchase possible period: October 1 to October 3, usable period: 10 AM to 2 PM October 3, estimated time of arrival at target business: 11:30 AM October 2)] is searched around the calculated optimal route, the social-commerce deal extractor 202 can purchase the searched three deals, that is, the A deal, the B deal, and the C deal at the current time and determine the usable A deal as the recommendation social-commerce deal during the movement and provide the determined recommendation social-commerce deal to the user. The following Table 2 is a table in which the information on the foregoing three deals and the recommendations are briefly arranged.

TABLE 2

| | | | Estimated | |
|---|---|---|---|---|
| Searched | Purchasable | Usable | Time Of | Recom- |
| Deal | Period | Period | Arrival | mendation |
| A | 10.01~10.02 | 10 AM to 2 PM | 11:30 AM | Recom- |
| | | October 2 | October 2 | mendation |
| B | 10.01 | 6 PM to 10 PM | 1:30 PM | Non- |
| | | October 2 | October 2 | Recom- |
| | | | | mendation |
| C | 10.01~10.03 | 10 AM to 2 PM | 11:30 AM | Non- |
| | | | | Recom- |
| | | October 3 | October 2 | mendation |

The example shown in the foregoing Table 2 is only an exemplary embodiment and therefore, when various conditions are set and applied, it is apparent to those skilled in the art that any cases belong to the scope of the present invention as far as they include the gist of the present invention.

As described above, the social-commerce deal extractor 202 may be configured to determine the recommendation social-commerce deals by various references (preset distance and/or estimated time of arrival at target businesses) and extract the determined recommendation social-commerce deals and may appropriately set at least one reference as needed.

The social-commerce deal processor 204 according to the exemplary embodiment of the present invention first performs to a function of receiving the social-commerce deal registration request transmitted from the advertiser terminal 120 to register the social-commerce deals of the corresponding advertisers in the server. Further, the social-commerce deal processor 204 performs a series of e-commerce processes for purchasing the social-commerce deals by interworking with the user terminal 100 when the purchase for the specific social-commerce deals is requested from the user terminal 100 and transmits the social-commerce deal complete information to the advertiser terminal 120 while transmitting the coupon information that can be used in the corresponding social-commerce deal target business to the user terminal 100 when the purchase for the social-commerce deals is successfully completed. The function of the social-commerce deal processor 204 is similar to the function of the general social-commerce server 130 and therefore, the detailed description thereof will be omitted herein.

The coupon manager 206 according to an exemplary embodiment of the present invention performs a function of searching whether the businesses in which the coupons owned by the user can be used are present around the route based on the route information calculated in the route calculator 200 and when the social-commerce businesses in which the coupons owned by the user can be used are present, generating the coupon use recommendation information and provide the generated coupon use recommendation information to the user terminal 100. In this case, the surroundings of the optimal routes mean the case in which the shops of the businesses are present within the preset distance from the optimal routes or the preset coupon use recommendation distance as described above. In order to perform the function, the database 132 of the social-commerce server 130 according to the exemplary embodiment of the present invention may be structurally stored with the coupon information of the user registered as a member and in order to perform the coupon use recommendation function, the social-commerce server 130 may request the user identification information (unique identification information such as ID/password, resident registration number, and the like) to the user terminal 100. The coupon manager 206 is configured to extract the coupon information of the corresponding user stored in the database 132 using the user identification information transmitted from the user terminal 100 and determine the recommendation target coupon according to the preset reference. In this case, the reference used to determine the recommendation target coupon may identically apply the reference for determining the recommendation social-commerce deals, that is, the preset distance and/or the estimated time of arrival at the corresponding businesses. The coupon manager 206 generates the coupon use recommendation information on the recommendation coupons owned by the user determined according to the set recommendation reference and transmits the generated coupon use recommendation information to the user terminal 100.

The advertiser manager 208 according to an exemplary embodiment of the present invention performs a function of performing the general management function for the advertisers (registration, registration information storage/change, and the like) and transmitting the reservation information (including the information on the automatically calculated estimated time of arrival at the corresponding businesses or the time information on the reservation request by the user) to the advertiser terminal 120 when the use confirmation request (reservation request) for the specific coupon is received according to the purchase information (including the information on the estimated time when the user arrives) and the request from the user terminal 100 in the case in which the purchase for the specific social-commerce deal is performed according to the request from the user terminal 100. Further, the deal purchase information may be configured to be transmitted to the advertiser terminal 120 by the foregoing social-commerce deal processor 204.

Each component (the route calculator 200, the social-commerce deal extractor 202, the social-commerce deal processor 204, the coupon processor 206, the advertiser manager 208) of the social-commerce server 130 of FIG. 2 may be implemented using software, hardware, or a combination of software and hardware within a single machine and may be physically implemented in another machine or the plurality of machines performing the same functions that are physically present may be present in parallel. As described above, it is apparent to those is skilled in the art that the present invention is not limited to the physical number and the positions of machines in which each component is installed or databases and therefore, can be variously changed in design.

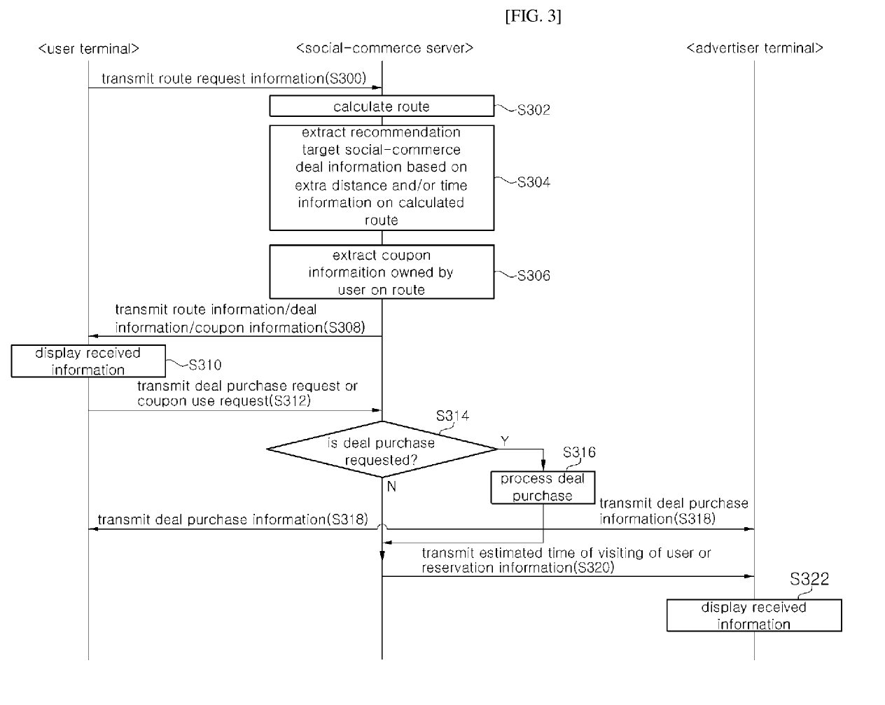

FIG. 3 is a flow chart showing a process of providing social-commerce deals with route information according to an exemplary embodiment of the present invention. Hereinafter, the process of providing social-commerce deal that is performed by the social-commerce server 130 according to an exemplary embodiment of the present invention will be described in detail with reference to FIG. 3.

First, the user terminal 100 accesses the social-commerce server 130 through the network 110 according to the operation of the user and transmits the route request information (including at least one of the origination information, the designation information, the passage information, the mobile device information, the departure information, and the setting information for other route calculation) input according to the operation of the user to the social-commerce server 130 (S300). In this case, the social-commerce server 130 may be configured to request the user identification information for logging-in the user terminal 100 accessed through the network 110. In this case, the user terminal 100 transmits the input user identification information (ID/password, and the like) to the social-commerce server 130 according to the operation of the user before or after the transmission of the route request information or simultaneously with or after the transmission of the route request information.

The social-commerce server 130 receives the route request information transmitted from the user terminal 100 and calculates the optimal routes according to the setting of the user based on the information included in the received route request information (S302). In this case, as described above, the social-commerce server 130 may be configured to interwork with the external traffic information server to acquire the real-time traffic situation information and use the acquired real-time traffic situation information for the optimal route calculation.

When the optimal route calculation is completed, the social-commerce server 130 performs the process of determining/extracting the recommendation social-commerce deal information that is to be recommended to the user among the plurality of registered social-commerce deals using the preset recommendation reference (the preset distance and/or the estimated time of arrival at the shops of the businesses) (S304). For example, in the case of the exemplary embodiment of the present invention configured to use both of the preset distance and the estimated time of arrival at the shops of the businesses as the reference, the social-commerce server 130 extracts all the social-commerce deals within the set preset distance from the calculated optimal routes and secondarily extracts the deal purchase and the social-commerce deals in which the coupons can be used according to the deal purchase based on the estimated time of arrival at the each of the extracted social-commerce deal target businesses and finally determines as the recommendation social-commerce deals the social-commerce deals suitable for the businesses according to the estimated time of arrival with reference to the recommendation reference information table among the secondarily extracted social-commerce deals.

Further, when the optimal route calculation is completed, the social-commerce server 130 extracts all the coupon information currently owned by the corresponding user using the user identification information transmitted from the user terminal 100 and then, determines the usable coupons as the use recommendation coupon at the time of movement through the calculated routes among the coupons currently owned by the user using the preset recommendation reference (the preset distance and/or the estimated time of arrival at the shops of the businesses) and extracts the determined use recommendation coupons (S306). The determination of the use recommendation coupons may be performed simultaneously with the foregoing recommendation social-commerce deal determination at different time from the determination and is substantially independent of the execution sequence.

When the optimal route calculation, the recommendation social-commerce deal information extraction, and/or the use recommendation coupon extraction are completed, the social-commerce server 130 transmits the calculated route information, the recommendation social-commerce deal information, and the coupon use recommendation information to the user terminal 100 (S308). As described above, the information itself may be transmitted to the user terminal 100 so as to be displayed through the applications that are installed in the user terminal 100 and the web page (or wap page) in which the calculated route information, the recommendation social-commerce deal information, and the coupon use recommendation information are displayed on the electronic map may also be provided to the user terminal 100.

The user terminal 100 that receives the route information, the recommendation social-commerce deal information, and the coupon use recommendation information from the social-commerce server 130 displays the information received through the applications installed therein or outputs the web page (wap page) including the route information, the recommendation social-commerce deal information, and the coupon use recommendation information (S310). In this case, the recommendation social-commerce deal information and the coupon use recommendation information that are displayed on the user terminal 100 may be displayed as summary information (icon, and the like) on the electronic map at one portion of the screen and the related detailed information may also be configured to be displayed on the other portion of the screen.

The user confirming the route information, the recommendation social-commerce deal information, and the coupon use recommendation information output through the user terminal 100 clicks (touches) the social-commerce deal information to be purchased or clicks (touches) the coupon information of which the use is decided and the user terminal 100 transmits the social-commerce deal purchase request or the coupon use request to the social-commerce server 130 according to the operation of the user (S312).

The social-commerce server 130 receiving the information from the user terminal 100 parses the received information to provide the interface screen for purchasing the social-commerce deal to the user terminal 100 when the received information corresponds to the deal purchase request and progresses the social-commerce deal purchase procedure using the information transmitted through the corresponding interface (S314 and S316).

When the social-commerce deal purchase procedure of the user is normally completed, the social-commerce server 130 transmits the deal purchase information to the user terminal 100 and the advertiser terminal 120 (S318). In this case, the deal purchase information transmitted to the advertiser terminal 120 preferably includes the information on the calculated estimated time of arrival at the corresponding businesses of the user.

On the other hand, when the information transmitted from the user terminal 100 is the coupon use request, the social-commerce server 130 transmits the coupon information owned by the corresponding user and the information (or the reservation time set by the user) on the estimated time of arrival of the corresponding user to the advertiser terminal 120 (S320).

The advertiser terminal 120 receives and displays the information (deal purchase information, the information on the estimated time of visiting of the user, the reservation information, and the like) transmitted from the social-commerce server 130 (S322).

The exemplary embodiments of the present invention are implemented in program command types performed by various computer means and may be recorded in a computer readable medium. The computer readable medium may include program commands, data fields, a data structure, and the like, alone or a combination thereof. The program commands recorded in the medium is specially designed and configured for the present invention or may be used by being known to those skilled in the art of computer software. An example of the computer readable recording medium may include magnetic media such as hard disk, floppy disk, magnetic tape, and the like, optical media such as CD-ROM, DVD, and the like, magneto-optical media such as optical disk, and hardware devices specially configured to store and perform program commands such as ROM, RAM, flash memory, and the like. An example of the program commands may include a machine language code made by a compiler and a high-level language code executable by a computer using an interpreter, and the like. The above-mentioned hardware devices may be configured to be operated as at least one software module so as to perform an operation of the present invention, and vice versa.

As described above, the present invention is described with reference to specific matters such as the detailed components and the limited exemplary embodiments and drawings, but is provided to help a general understanding of the present invention. Therefore, the present invention is not limited to the above exemplary embodiments and can be variously changed and modified from the description by a person skilled in the art to which the present invention pertain.

The spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. A method for providing social-commerce deals with route information executed by a social-commerce server, the method comprising:
receiving route request information from a terminal and calculating route information based on the received route request information;
extracting, by the social-commerce server, recommendation social-commerce deal information based on the calculated route information; and
providing the calculated route information and the extracted recommendation social-commerce deal information to the terminal.

2. The method of claim 1, wherein the route request information comprises at least one of origination information, destination information, and moving device information.

3. The method of claim 1, wherein the extracted recommendation social-commerce deal information is deal information of businesses located within a preset distance from the calculated route.

4. The method of claim 3, wherein the preset distance is set according to distance setting information transmitted from the terminal.

5. The method of claim 1, wherein the extracted recommendation social-commerce deal information is extracted based on an estimated time of arrival at a business, the estimated time of arrival being calculated based on the route information.

6. The method of claim 5, wherein the recommendation social-commerce deal information is extracted based on whether a deal associated with the recommendation social commerce deal information is capable of being used at the estimated time of arrival at businesses.

7. The method of claim 1, further comprising: determining whether social-commerce coupons of businesses located around the calculated route information among social-commerce coupons owned by a user of the terminalexist and if so, further providing use recommendation information of the corresponding social-commerce coupons to the terminal.

8. The method of claim 7, further comprising: receiving a use reservation request for specific social-commerce coupons owned by the user from the terminal and transmitting reservation information to an advertiser terminal corresponding to the specific social-commerce coupons.

9. The method of claim 8, wherein the reservation information comprises an estimated time of arrival at a corresponding business,the estimated time of arrival being calculated based on the route information.

10. The method of claim 1, further comprising: receiving, from the terminal, a purchase request of the social-commerce deals and transmitting purchase complete information of the purchased social-commerce deals to the terminal and an advertiser terminal.

11. The method of claim 10, wherein the purchase complete information of the social-commerce deals comprises an estimated time of arrival at a corresponding business, is the estimated time of arrival being calculated based on the route information.

12. A non-transitory computer readable medium comprising an executable program which, when executed, performs a method for providing social-commerce deals with route information, the method comprising:
receiving route request information from a user terminal and calculating route information based on the received route request information;
extracting recommended social-commerce deal information based on the calculated route information; and
providing the calculated route information and the extracted recommendation social-commerce deal information to the user terminal.

13. A server configured to provide social-commerce deals with route information, the server comprising:
one or more processors configured to communicate with one or more storage devices, the one or more storage devices comprising:
a route calculator configured to receive route request information from a terminal and calculate route information based on the received route request information; and
a social-commerce deal extractor configured to extract recommendation social-commerce deal information based on the calculated route information and provide the calculated route information and the extracted recommendation social-commerce deal information to the terminal.

14. The server of claim 13, wherein the route request information comprises at least one of origination information, destination information, and moving device information.

15. The server of claim 13, wherein the extracted recommendation social-commerce deal information is deal information of businesses located within a preset distance from the calculated route.

16. The server of claim 13, wherein the extracted recommendation social-commerce deal information is extracted based on an estimated time of arrival at a corresponding business, the estimated time of arrival being calculated based on the route information.

17. The server of claim 16, wherein the recommendation social-commerce deal information is extracted based on whether it is used at the estimated time of arrival at businesses.

18. The server of claim 13, wherein a coupon manager configured to determine whether social-commerce coupons of businesses located around the calculated route information among social-commerce coupons owned by a user of a terminal are present and if so, further provide use recommendation information of the corresponding coupons to the user terminal.

19. The server of claim 18, wherein an advertiser manager configured to receive a use reservation request for specific social-commerce coupons owned by the user from the terminal and transmit reservation information to an advertiser terminal of the specific social-commerce coupons.

20. The server of claim 13, wherein a social-commerce deal processor configured to receive a purchase request of the social-commerce deals transmitted from the terminal to perform purchase processing of the social-commerce deals and transmit purchase complete information of the social-commerce deals to the terminal and an advertiser terminal.
